(19) United States
(12) Patent Application Publication
(10) Pub. No.: US 2019/0293459 A1
(43) Pub. Date: Sep. 26, 2019

(54) POWER TRANSMISSION DEVICE

(71) Applicant: EXEDY Corporation, Osaka (JP)

(72) Inventor: Keiichi YASUDA, Osaka (JP)

(21) Appl. No.: 16/282,736

(22) Filed: Feb. 22, 2019

(30) Foreign Application Priority Data
Mar. 20, 2018 (JP) 2018-051992
Feb. 6, 2019 (JP) 2019-019699

(51) Int. Cl. G01D 11/24; F16H 41/24; F16H 45/02

(52) U.S. Cl. CPC G01D 11/245; F16H 45/02; F16H 41/24

(57) ABSTRACT

A power transmission device for transmitting a torque from a drive source to a drive wheel includes a housing, an electric component, a power receiving unit, and a power transmitting unit. The housing is rotatable and receives a torque transmitted from the drive source. The electric component is attached to the housing. The power receiving unit is electrically connected to the electric component. Further, the power receiving unit is attached to an outer peripheral surface of the housing. The power transmitting unit is disposed outside of the housing at an interval from the power receiving unit. In addition, the power transmitting unit transmits power to the power receiving unit in a non-contact manner.

### CROSS-REFERENCES TO RELATED APPLICATIONS

This application claims the benefit of priority to Japanese Patent Application No. 2018-051992, filed on Mar. 20, 2018 and Japanese Patent Application No. 2019-019699, filed on Feb. 6, 2019. The contents of those applications are herein incorporated by reference in their entireties.

### TECHNICAL FIELD

The present disclosure relates to a power transmission device.

### BACKGROUND ART

A power transmission device, for example a torque converter, includes a front cover, an impeller, a turbine, and a lock-up clutch. The front cover and the impeller shell constitute a housing of the torque converter. The turbine and the lock-up clutch are rotatably disposed in the housing. The interior of the housing is filled with fluid such as hydraulic fluid. See Japanese Unexamined Patent Application Publication No. 2017-101744.

### BRIEF SUMMARY

In the present disclosure, an electric component such as a sensor is used for detecting the state of a power transmission device for the purpose of improving the performance of a power transmission device such as a torque converter. When installing such an electric component, the electric component requires power supply. The power transmission device rotates by the torque from a drive source, and therefore wireless power supply is required to the electric component attached to the power transmission device. In such wireless power supply, it is desired that electric power is stably supplied to the electric component.

An objective of the present disclosure is to provide a power transmission device capable of stably supplying electric power to electric components thereof.

A power transmission device according to a first aspect of the present disclosure is configured to transmit a torque from a drive source to a drive wheel. The power transmission device includes a housing, an electric component, a power receiving unit, and a power transmitting unit. The housing is rotatably disposed and receives the torque transmitted from the drive source. The electric component is attached to the housing. The power receiving unit is electrically connected to the electric component. Further, the power receiving unit is attached to an outer peripheral part of the housing. The power transmitting unit is disposed outside the housing, at an interval from the power receiving unit. In addition, the power transmitting unit transmits electric power to the power receiving unit in a non-contact manner.

When a power transmission device such as a torque converter is operated, the dimensional change in the housing of the power transmission device is smaller in the outer peripheral part far from the rotational axis than in the inner peripheral part close to the rotational axis. In the present disclosure, therefore, the power receiving unit is disposed on the outer peripheral part of the housing. According to this configuration, the distance between the power receiving unit and the power transmitting unit can be kept more constant as compared with the configuration in which the power receiving unit is disposed on the inner peripheral part of the housing. By keeping the distance between the power receiving unit and the power transmitting unit constant, it is possible to stabilize the amount of power supply. As a result, this configuration allows electric power to be stably supplied to the electric components. Note that the outer peripheral part of the housing refers to a portion outside from 80% of the maximum radius of the housing.

Preferably, the power receiving unit is attached to an outer peripheral surface of the housing, and the power transmission unit is radially disposed at an interval from the power receiving unit.

Preferably, the power receiving unit is attached to an outer peripheral surface of the housing, and the power transmission unit is axially disposed at an interval from the power receiving unit.

A power transmission device according to a second aspect of the present disclosure is configured to transmit a torque from a drive source to a drive wheel. The power transmission device includes a housing, a rotating body, an electric component, a first power receiving unit, a first power transmitting unit, a second power receiving unit, and a second power transmitting unit. The housing is rotatably disposed and receives the torque transmitted from the drive source. The rotating body is disposed in the housing to be relatively rotatable with the housing. The electric component is attached to the rotating body. The first power receiving unit is electrically connected to the electric component and is attached to an outer peripheral surface of the rotating body. The first power transmitting unit is attached to an inner side surface of the housing and is disposed at an interval from the first power receiving unit. In addition, the first power transmitting unit transmits electric power to the first power receiving unit in a non-contact manner. The second power receiving unit is attached to an outer peripheral part of the housing and is electrically connected to the first power transmitting unit. The second power transmitting unit is disposed outside the housing at an interval from the second power receiving unit. In addition, the second power transmitting unit transmits electric power to the second power receiving unit in a non-contact manner.

According to this configuration, the first power receiving unit is attached to an outer peripheral part of the rotating body, and therefore the interval between the first power receiving unit and the first power transmitting unit can be kept more constant as compared with the configuration in which the first power receiving unit is attached to an inner peripheral part of the rotating body. In addition, the second power receiving unit is attached to an outer peripheral part of the housing, and therefore the interval between the second power receiving unit and the second power transmitting unit can be kept more constant as compared with the configuration in which the second power receiving unit is attached to an inner peripheral part of the housing. With this configuration in which the interval between the first power receiving unit and the first power transmitting unit and the interval between the second power receiving unit and the second power transmitting unit are kept constant, it is possible to stabilize the amount of power supply. Therefore, electric power can be stably supplied to the electric components. Note that the outer peripheral part of the rotating body refers to a portion outside from 80% of the maximum radius of the rotating body.

Preferably, the first power receiving unit is attached to an outer peripheral surface of the rotating body, and the first power transmission unit is radially disposed at an interval from the first power receiving unit.

Preferably, the first power receiving unit is attached to an outer peripheral surface of the rotating body, and the first power transmission unit is axially disposed at an interval from the first power receiving unit.

Preferably, the second power receiving unit is attached to an outer peripheral surface of the housing, and the second power transmission unit is radially disposed at an interval from the second power receiving unit.

Preferably, the second power receiving unit is attached to an outer peripheral surface of the housing, and the second power transmission unit is axially disposed at an interval from the second power receiving unit.

Preferably, the rotating body is movable in the axial direction.

Preferably, the electric component is a state detecting unit for detecting a state of the power transmission device in the housing.

According to the present disclosure, electric power can be stably supplied to an electric product.

### BRIEF DESCRIPTION OF THE DRAWINGS

FIG. 1 is a cross-sectional view of a power transmission device.

FIG. 2 is an enlarged sectional view of the power transmission device.

FIG. 3 is a flowchart showing an operation of a control unit.

FIG. 4 is an enlarged sectional view of a power transmission device according to a modified example.

FIG. 5 is an enlarged sectional view of a power transmission device according to a modified example.

FIG. 6 is an enlarged sectional view of a power transmission device according to a modified example.

### DETAILED DESCRIPTION

Hereinafter, embodiments of a power transmission device according to the present disclosure will be described with reference to the drawings.

### [Overall Configuration]

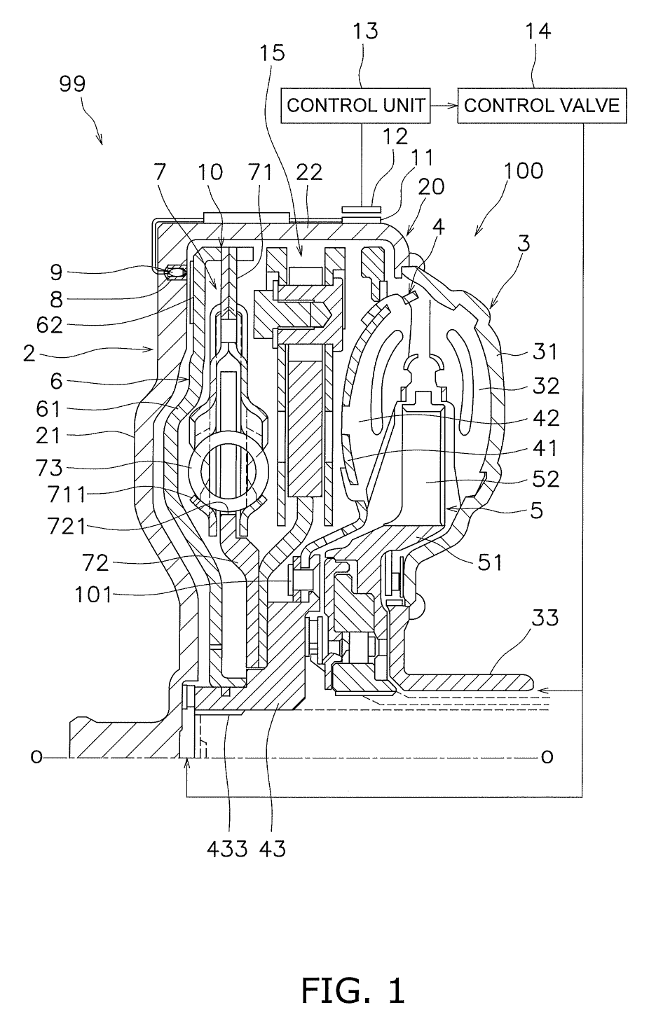

FIG. 1 is a cross-sectional view of a power transmission device 99 according to an embodiment of the present disclosure. The power transmission device 99 includes a torque converter 100. In the following description, the term “axial direction” means an extending direction of a rotational axis O of the torque converter 100. In addition, the term “circumferential direction” refers to a circumferential direction of a circle about the rotational axis O of the torque converter, and the term “radial direction” means a radial direction of a circle about the rotational axis O of the torque converter. The inner side in the radial direction refers to a side approaching the rotational axis O in the radial direction and the outer side in the radial direction refers to a side moving away from the rotational axis O in the radial direction. It should be noted that an engine is disposed on the left side of FIG. 1 whereas a transmission is disposed on the right side of FIG. 1, although the engine and the transmission are not shown in the drawing.

The torque converter 100 is configured to transmit a torque from an engine, which is a drive source, to a drive wheel. The torque converter 100 is rotatable around the rotational axis O. The torque converter 100 includes a front cover 2, an impeller 3, a turbine 4, a stator 5, a lock-up device 10, and a dynamic vibration absorbing device 15. The power transmission device 99 includes the torque converter 100, a heat conducting unit 8, a temperature detecting unit 9, a power receiving unit 11, a power transmitting unit 12, and a control unit 13.

### [Front Cover]

Torque from the engine (an example of a drive source) is inputted to the front cover 2. The front cover 2 includes a disc part 21 and a tubular part 22. The tubular part 22 extends in the axial direction from an outer peripheral end part of the disc part 21 toward the impeller 3.

### [Impeller 3]

The impeller 3 includes an impeller shell 31, a plurality of impeller blades 32, and an impeller hub 33. An outer peripheral end part of the impeller shell 31 is fixed to a front tip part of the tubular part 22 of the front cover 2. For example, the impeller shell 31 is fixed to the front cover 2 by welding.

The impeller blades 32 are fixed to the inner surface of the impeller shell 31. The impeller hub 33 is fixed to the inner peripheral part of the impeller shell 31 by welding or the like.

The impeller shell 31 and the front cover 2 constitute a housing 20 of the torque converter 100. The interior of the housing 20 is filled with fluid. More specifically, the interior of the housing 20 is filled with hydraulic oil. The housing 20 is rotatably disposed and receives the torque transmitted from the engine. The housing 20 has a through hole 211. The through hole 211 is, for example, cylindrical in shape. The through hole 211 communicates the inside and the outside of the housing 20. The through hole 211 is formed in the disc part 21 of the front cover 2. The through hole 211 penetrates the disc part 21 of the front cover 2 in the axial direction.

### [Turbine 4]

The turbine 4 is disposed so as to face the impeller 3. The turbine 4 includes a turbine shell 41, a plurality of turbine blades 42, and a turbine hub 43. The turbine blades 42 are fixed to an inner surface of the turbine shell 41 by brazing or the like.

The turbine shell 41 is fixed to the turbine hub 43 by rivets 101. A spline hole 433 is formed in an inner peripheral surface of the turbine hub 43. An input shaft of the transmission is spline-fitted to the spline hole 433.

### [Stator 5]

The stator 5 is configured to rectify the hydraulic fluid that returns from the turbine 4 to the impeller 3. The stator 5 is rotatable around the rotational axis O. The stator 5 includes a stator carrier 51 and a plurality of stator blades 52.

### [Lock-Up Device 10]

The lock-up device 10 is configured to mechanically transmit torque from the front cover 2 to the turbine hub 43. The lockup device 10 is disposed between the front cover 2 and the turbine 4 in the axial direction. The lockup device 10 includes a clutch unit 6 and a damper mechanism 7.

The clutch unit 6 includes a piston 61 and a friction member 62. The piston 61 has a disc shape and includes a through hole in the center thereof. The turbine hub 43 extends through the through hole of the piston 61. The outer circumferential surface of the turbine hub 43 and the inner circumferential surface of the piston 61 are sealed to each other.

The piston 61 is disposed so as to be relatively rotatable to the housing 20. Furthermore, the piston 61 is disposed so as to be relatively rotatable to the turbine hub 43. The piston 61 is disposed movably in the axial direction. More specifically, the piston 61 is slidable on the turbine hub 43 in the axial direction.

The friction member 62 is annular in shape. The friction member 62 is fixed to the piston 61. More specifically, the friction member 62 is fixed to an outer peripheral end part of the piston 61. The friction member 62 is disposed so as to face the through hole 211 formed in the disc part 21 of the front cover 2. That is, the friction member 62 and the through hole 211 oppose each other in the axial direction.

Upon moving the clutch unit 6 in the axial direction to the side of the front cover 2 (the left side in FIG. 1), the friction member 62 of the clutch unit 6 comes in contact with the disc part 21 of the front cover 2 and frictionally engages therewith. As a result, the clutch unit 6 is brought into a frictional engagement state and rotates integrally with the front cover 2. Under this frictional engagement state, the torque inputted to the front cover 2 is outputted from the turbine hub 43 via the lock-up device 10.

On the other hand, as the clutch unit 6 moves in the axial direction away from the front cover 2 (the right side in FIG. 1), the friction member 62 of the clutch unit 6 separates from the disc part 21 of the front cover 2 and is no longer in contact with the disc part 21. As a result, the clutch unit 6 is brought into a released state in which the frictional engagement between the friction member 62 and the disc part 21 is released, and becomes relatively rotatable with the front cover 2. Note that in this released state, the torque inputted to the front cover 2 is outputted from the turbine hub 43 via the impeller 3 and the turbine 4.

In addition, the clutch unit 6 can assume a slip state. In this slip state, while the friction member 62 and the disc part 21 are in contact with each other, the clutch unit 6 is frictionally engaged with a force that is weaker than that in the frictional engagement state. Therefore, the friction member 62 and the disc part 21 are caused to slip while being frictionally engaged. Under the slip state, part of the torque inputted to the front cover 2 is outputted from the turbine hub 43 via the impeller 3 and the turbine 4 while the rest of the torque is outputted from the turbine hub 43 via the lock-up device 10.

The damper mechanism 7 is disposed between the piston 61 and the turbine 4 in the axial direction. The damper mechanism 7 includes a drive plate 71, a driven plate 72, and a plurality of torsion springs 73.

The drive plate 71 is formed in a disc shape, and an outer peripheral end part thereof is engaged with the piston 61. Therefore, the drive plate 71 rotates integrally with the piston 61. Moreover, the drive plate 71 and the piston 61 move relative to each other in the axial direction. The drive plate 71 has a plurality of accommodating parts 711 arranged at intervals in the circumferential direction.

The driven plate 72 is formed in a disc shape. The driven plate 72 is fixed to the turbine hub 43. More specifically, an inner peripheral end part of the driven plate 72 is fixed to the turbine hub 43 by welding or the like. The driven plate 72 has a plurality of accommodating parts 721 arranged at intervals in the circumferential direction. The accommodating parts 721 of the driven plate 72 are disposed so as to overlap with the accommodating parts 711 of the drive plate 71 as viewed in the axial direction.

The torsion springs 73 are housed in the accommodating parts 711 of the drive plate 71 and the accommodating parts 721 of the driven plate 72. The torsion springs 73 elastically couple the drive plate 71 and the driven plate 72.

With the above configuration, the torque inputted to the clutch unit 6 is outputted from the turbine hub 43 via the drive plate 71, the torsion springs 73, and the driven plate 72.

### [Dynamic Vibration Absorbing Device]

The dynamic vibration absorbing device 15 is disposed between the lock-up device 10 and the turbine 4. The dynamic vibration absorbing device 15 is attached to the turbine 4. More specifically, the dynamic vibration absorbing device 15 is attached to the turbine hub 43.

### [Heat Conducting Unit]

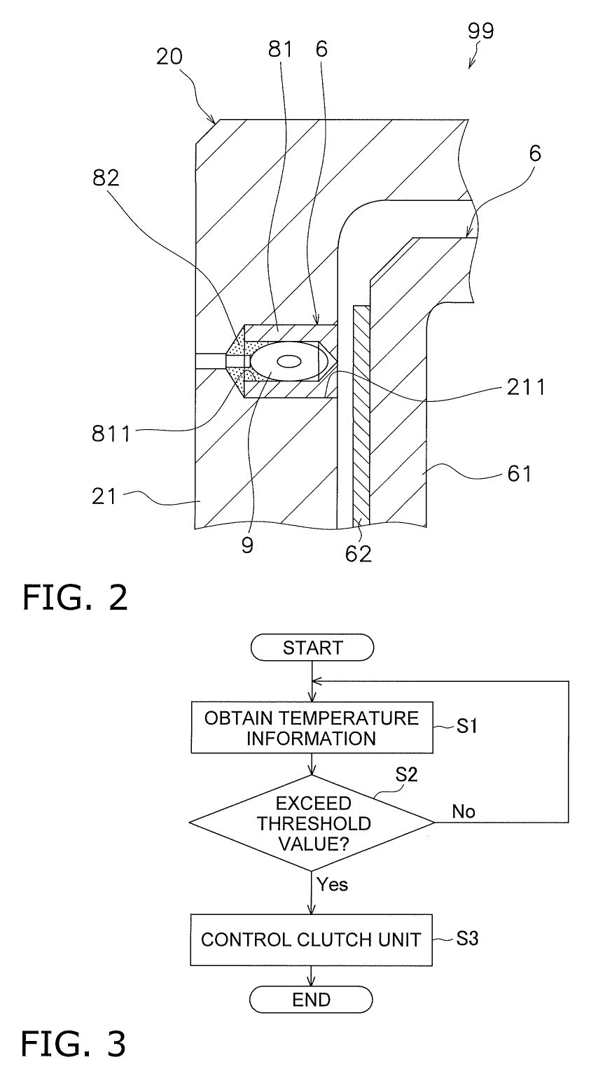

As shown in FIG. 2, the heat conducting unit 8 is mounted inside the through hole 211 formed in the disc part 21 of the front cover 2. The heat conducting unit 8 is exposed in the housing 20. More specifically, the surface of the heat conducting unit 8 that faces the friction member 62 is substantially flush with the inner surface of the disc part 21 without any difference in level.

The heat conducting unit 8 includes a metal plug 81 and a molding material 82. The metal plug 81 is fitted into the through hole 211 so as to close the through hole 211. Specifically, the metal plug 81 is press-fitted into the through hole 211.

The metal plug 81 has a higher thermal conductivity than the front cover 2. For example, the thermal conductivity of the metal plug 81 is preferably 1.5 times or more higher than the thermal conductivity of the front cover 2. When the front cover 2 is made of an iron-based material, the metal plug 81 is preferably 100 w/mK, for example, and can be made of elements such as copper, aluminum, or silver.

The metal plug 81 is cylindrical in shape and has a recess portion 811. The recess portion 811 opens toward the side that is opposite from the friction member 62 (the left side in FIG. 2). A temperature detecting unit 9 is accommodated in the recess portion 811.

The molding material 82 fills a gap in the through hole 211. More specifically, the molding material 82 fills a gap in the recess portion 811 of the metal plug 81 in which the temperature detecting unit 9 is accommodated. Filling the gap with the molding material 82 as described above allows more reliable thermal conductivity to be carried out between the metal plug 81 and the temperature detecting unit 9.

The molding material 82 can be made of, for example, a resin. As the resin constituting the molding material 82, for example, an epoxy resin, a silicone resin, a phenol resin, or the like can be used. In addition, the molding material 82 contains heat conductive particles. The heat conductive particles are dispersed in the molding material 82. The heat conductive particles have higher thermal conductivity than the resin which constitutes the molding material 82. For example, similarly to the metal plug 81, the thermal conductivity of the heat conductive particles is preferably 1.5 times or more higher than the thermal conductivity of the front cover 2. Thus, the heat conducting unit 8 is configured in this manner by pouring and solidifying the molding material 82 containing the heat conductive particles into the gap in the recess portion 811 of the metal plug 81 in which the temperature detecting unit 9 is accommodated.

### [Temperature Detecting Unit]

The temperature detecting unit 9 is configured to detect the temperature of the friction surface of the friction material 62 via the heat conducting unit 8. The temperature detecting unit 9 is, for example, a negative characteristic thermistor. It should be noted that the temperature detecting section 9 can be a positive temperature coefficient thermistor or a thermocouple. Note that this temperature detecting unit 9 corresponds to the electric component of the present disclosure.

The temperature detecting unit 9 is embedded in the heat conducting unit 8. More specifically, the temperature detecting unit 9 is accommodated in the recess portion 811 of the metal plug 81. Then, the recess portion 811 is filled with the molding material 82 so as to embed the temperature detecting unit 9 accommodated in the recess portion 811. The temperature detecting unit 9 is wire connected to a power receiving unit 11 by an electric wire or the like.

### [Power Receiving Unit]

As shown in FIG. 1, the power receiving unit 11 is electrically connected to the temperature detecting unit 9. More specifically, the power receiving unit 11 and the temperature detecting unit 9 are wire connected by electric wires or the like. The power receiving unit 11 is attached to an outer peripheral part of the housing 20. More specifically, the power receiving unit 11 is attached to the outer peripheral surface of the housing 20. More specifically, the power receiving unit 11 is attached to an outer peripheral surface of the tubular part 22 constituting the outer peripheral wall of the housing 20. The power receiving unit 11 is configured with, for example, a power receiving coil.

### [Power Transmitting Unit]

The power transmitting unit 12 is disposed, outside of the housing 20, at an interval from the power receiving unit 11. More specifically, the power transmitting unit 12 is disposed radially outward of the power receiving unit 11 and spaced apart therefrom. For example, the power transmitting unit 12 can be attached to an inner wall surface of a housing accommodating the torque converter 100. The power transmitting unit 12 is configured to transmit power to the power receiving unit 11 in a non-contact manner. That is, the power transmitting unit 12 transmits power to the power receiving unit 11 by means of wireless power supply. It is to be noted that the wireless power supplying system between the power transmitting unit 12 and the power receiving unit 11 can be a magnetic field coupling system, an electric field coupling system, or an electromagnetic field coupling system. The power transmitting unit 12 is constituted by, for example, a power transmission coil.

### [Control Unit]

The control unit 13 controls a driving state of the torque converter 100 based on the temperature detected by the temperature detecting unit 9. In the present embodiment, the control unit 13 controls the clutch unit 6 as the driving state of the torque converter 100. More specifically, the control unit 13 controls the control valve 14 to control the hydraulic pressure acting on the clutch unit 6 and thereby move the clutch unit 6 in the axial direction.

Next, an operation of the control unit 13 will be explained. First, as shown in FIG. 3, the control unit 13 obtains information regarding the temperature detected by the temperature detecting unit 9 by wireless communication (step S1). For this wireless communication, a wireless chip and an antenna (not shown) are provided in the torque converter 100 and an antenna (not shown) is also provided in the control unit 13 to enable the construction of a telemetry system that performs wireless communication of digital modulation method or analog modulation method. Note that this wireless communication can be a load modulation communication method via the power receiving unit 11 and the power transmitting unit 12.

The control unit 13 determines whether or not the temperature detected by the temperature detecting unit 9 exceeds a preset threshold value (step S2). When determination has been made that the temperature detected by the temperature detecting unit 9 does not exceed the threshold value (“No” in step S2), the control unit 13 executes the process of step S1 again.

When determination has been made that the temperature detected by the temperature detecting unit 9 exceeds the threshold value (“Yes” in step S2), the control unit 13 controls the clutch unit 6 (step S3). For example, the control unit 13 causes the clutch unit 6 to move toward the front cover 2 in the axial direction to bring the clutch unit 6 into a friction engagement state. Alternatively, the control unit 13 causes the clutch unit 6 to move in a direction away from the front cover 2 in the axial direction, thereby bringing the clutch unit 6 into a released state. It is to be noted that, preferably, the control executed by the control unit 13 is performed when the clutch unit 6 is in the slip state.

### EXAMPLE MODIFICATIONS

An embodiment of the present disclosure has been described above; however, the present disclosure is not limited thereto, and various modifications are possible without departing from the spirit of the present disclosure.

### Example Modification 1

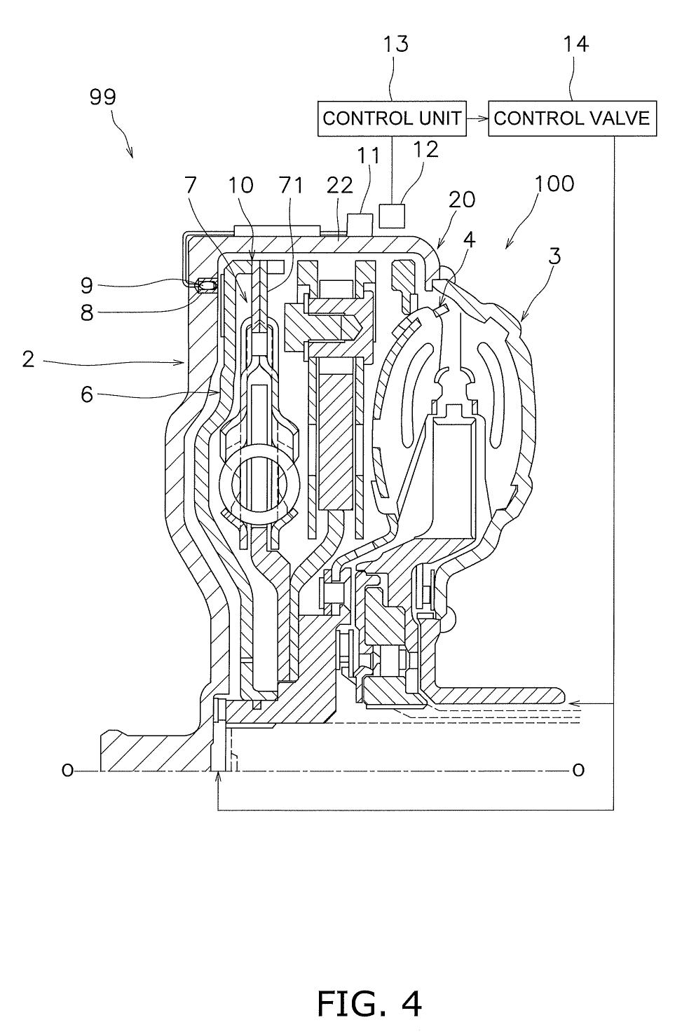

In the above embodiment, the power transmission unit 12 is disposed radially outward of the power receiving unit 11 and spaced apart therefrom, but the position of the power transmission unit 12 is not limited thereto. For example, as shown in FIG. 4, the power transmission unit 12 may be axially spaced apart from the power receiving unit 11. That is, the power transmission unit 12 may be disposed opposite to the power receiving unit 11 in the axial direction.

### Example Modification 2

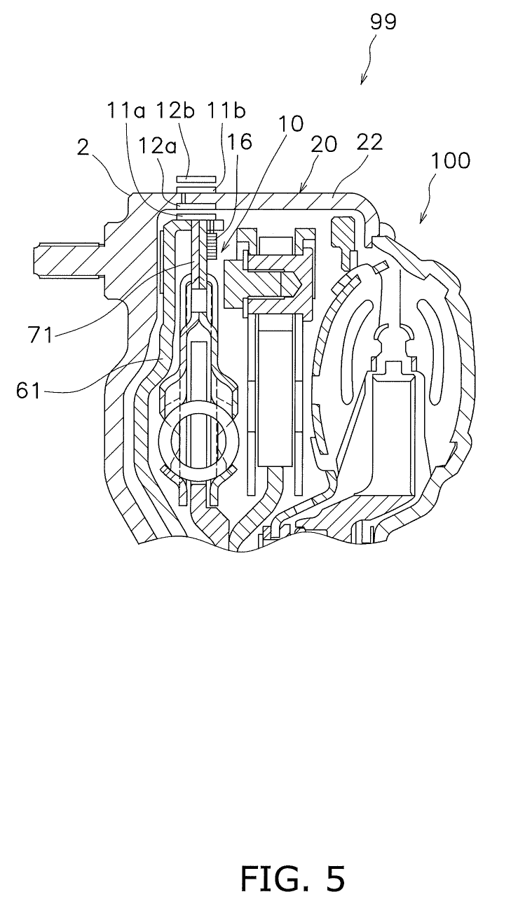

As shown in FIG. 5, an acceleration sensor 16 can be attached to the lock-up device 10 as an electric component. In this case, the lock-up device 10 corresponds to the rotating body of the present disclosure. It is to be noted that the acceleration sensor 16 is fixed to, for example, a drive plate 71. The torque converter 100 according to this example modification includes a first power receiving unit 11a, a first power transmitting unit 12a, a second power receiving unit 11b, and a second power transmitting unit 12b.

The first power receiving unit 11a is electrically connected to the acceleration sensor 16. For example, the first power receiving unit 11a is wire connected to the acceleration sensor 16 by an electric wire or the like. The first power receiving unit 11a is attached to an outer peripheral part of the lock-up device 10. More specifically, the first power receiving unit 11a is attached to an outer peripheral surface of the lock-up device 10. In this example modification, the first power receiving unit 11a is attached to an outer peripheral surface of the piston 61.

The first power transmitting unit 12a is attached to an inner side surface of the housing 20. More specifically, the first power transmitting unit 12a is attached to the inner peripheral surface of the housing 20. In this example modification, the first power transmitting unit 12a is attached to the inner peripheral surface of the tubular part 22 of the front cover 2. The first power transmitting unit 12a is disposed at an interval from the first power receiving unit 11a in the radial direction. The first power transmitting unit 12a is configured to transmit power to the first power receiving unit 11a in a non-contact manner.

The second power receiving unit 11b is attached to an outer peripheral part of the housing 20. More specifically, the second power receiving unit 11b is attached to an outer peripheral surface of the housing 20. In this example modification, the second power receiving unit 11b is attached to an outer peripheral surface of the tubular part 22 of the front cover 2. The second power receiving unit 11b is electrically connected to the first power transmitting unit 12a. For example, the second power receiving unit 11b is wire connected to the first power transmitting unit 12a by electric wires or the like.

The second power transmitting unit 12b is disposed, outside of the housing 20, at an interval from the second power receiving unit 11b. More specifically, the second power transmitting unit 12b is disposed radially outward of the second power receiving unit 11b. The second power transmitting unit 12b is disposed at an interval from the second power receiving unit 11b in the radial direction. The second power transmitting unit 12b is attached to, for example, an inner wall surface of the housing accommodating the torque converter 100. The second power transmitting unit 12b is configured to transmit power to the second power receiving unit 11b in a non-contact manner.

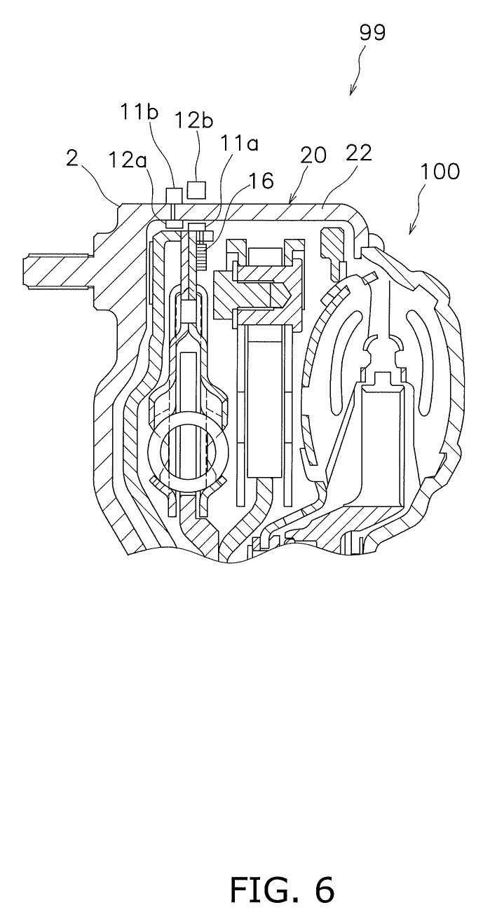

In Example Modification 2, as shown in FIG. 6, the first power transmission unit 12a may be axially spaced apart from the first power receiving unit 11a. That is, the first power transmission unit 12a may be disposed opposite to the first power receiving unit 11a in the axial direction.

Also the second power transmission unit 12b may be axially spaced apart from the second power receiving unit 11b. That is, the second power transmission unit 12b may be disposed opposite to the second power receiving unit 11b in the axial direction.

### Example Modification 3

Although the outer peripheral wall portion of the housing 20 is mainly constituted by the tubular part 22 of the front cover 2, the configuration is not particularly limited thereto. For example, the impeller shell 31 can include a disc part and a tubular part like the front cover 2. A configuration can be adopted in which the tubular part of the impeller shell 31 constitutes the outer peripheral wall portion of the housing 20, or the outer peripheral wall portion of the housing 20 can be formed by both the tubular part 22 of the front cover 2 and the tubular part of the impeller shell 31.

### Example Modification 4

In the aforementioned embodiment, the friction surface of the piston 61 faces the axial direction; however, the direction in which the friction surface of the piston 61 faces is not limited to the axial direction. For example, the friction surface of the piston 61 can face outward in the radial direction. Specifically, the friction member 62 can be fixed to an outer peripheral surface of the piston 61. In this case, the piston 61 moves in the radial direction, whereby the friction surface of the piston 61 frictionally engages with the inner peripheral surface of the outer peripheral wall portion of the housing 20. Further, the through hole 211 is formed in the outer peripheral wall portion of the housing 20.

### Example Modification 5

In the aforementioned embodiment, the clutch unit 6 includes the piston 61 and the friction member 62; however, the present disclosure is not limited thereto. For example, a friction surface can be directly formed on the outer peripheral end part of the piston 61.

### Example Modification 6

In the aforementioned embodiment, the control unit 13 controls the clutch part 6; however, the present disclosure is not limited thereto. For example, the control unit 13 can control the rotational speed per unit time of the engine which is the driving source. When determining that the threshold value has been exceeded, the control unit 13 can control the engine so that the rotational speed per unit time of the engine decreases.

### Example Modification 7

In the aforementioned embodiment, the heat conductive particles are contained in the resin mold member 82, but the configuration of the mold member 82 is not limited thereto. For example, the molding material 82 can be made of metal instead of resin. For instance, the molding material 82 can be made of elements such as copper, aluminum, or silver. In this case, it is not necessary to add the heat conductive particles into the molding material 82. In addition, for example, a configuration can be adopted in which a plurality of heat conductive particles are filled in the recess portion 811 and the molding material 82 is disposed so as to cover the recess portion 811.

### Example Modification 8

In the aforementioned embodiment, the clutch unit 6 is configured so that the friction member 62 directly contacts the housing 20; however, the configuration of the clutch unit 6 is not limited thereto. For example, a configuration can be adopted in which the clutch unit 6 is configured such that the friction surface frictionally engages with another member in a position away from the housing 20 but in the vicinity thereof. Even in that case, it is preferable to provide the through hole 211 in the housing 20 at a position facing the friction surface in the vicinity thereof, and to provide the heat conducting unit 8 and the temperature detecting unit 9 as in the above embodiment.

Moreover, in the aforementioned embodiment, the exemplified case is that the temperature detecting unit 9 has been configured as an electric component; however, the configuration of the electric component is not limited thereto. For example, the electric component can be a sensor component for detecting features or an actuator such as a motor or a solenoid, other than the temperature detecting unit.

### REFERENCE SIGNS LIST

9: Temperature Detecting Unit
11: Power Receiving Unit
11a: First Power Receiving Unit
11b: Second Power Receiving unit
12: Power Transmitting Unit
12a: First Power Transmitting Unit
12b: Second Power Transmitting Unit
15: Dynamic Vibration Absorbing Device
20: Housing
100: Torque Converter

What is claimed is:

1. A power transmission device for transmitting a torque from a drive source to a drive wheel, the power transmission device comprising:
a housing that is rotatable and receives the torque transmitted from the drive source;
an electric component attached to the housing;
a power receiving unit electrically connected to the electric component and attached to an outer peripheral part of the housing; and
a power transmitting unit that is disposed outside of the housing at an interval from the power receiving unit and that transmits power to the power receiving unit in a non-contact manner.

2. The power transmission device according to claim 1, wherein
the power receiving unit is attached to an outer peripheral surface of the housing, and
the power transmission unit is radially disposed at an interval from the power receiving unit.

3. The power transmission device according to claim 1, wherein
the power receiving unit is attached to an outer peripheral surface of the housing, and
the power transmission unit is axially disposed at an interval from the power receiving unit.

4. A power transmission device for transmitting a torque from a drive source to a drive wheel, the power transmission device comprising:
a housing that is rotatable and receives the torque transmitted from the drive source;
a rotating body disposed in the housing to be relatively rotatable with the housing;
an electric component attached to the rotating body;
a first power receiving unit electrically connected to the electric component and attached to an outer peripheral part of the rotating body;
a first power transmitting unit for transmitting electric power to the first power receiving unit in a non-contact manner, the first power transmitting unit attached to an inner side surface of the housing and disposed at an interval from the first power receiving unit;
a second power receiving unit attached to an outer peripheral surface of the housing and electrically connected to the first power transmitting unit; and
a second power transmitting unit for transmitting electric power to the second power receiving unit in a non-contact manner, the second power transmitting unit disposed outside of the housing at an interval from the second power receiving unit.

5. The power transmission device according to claim 4, wherein
the first power receiving unit is attached to an outer peripheral surface of the rotating body, and
the first power transmission unit is attached to an inner peripheral surface of the housing, and radially disposed at an interval from the first power receiving unit.

6. The power transmission device according to claim 4, wherein
the first power receiving unit is attached to an outer peripheral surface of the rotating body, and
the first power transmission unit is attached to an inner peripheral surface of the housing, and axially disposed at an interval from the first power receiving unit.

7. The power transmission device according to claim 4, wherein
the second power receiving unit is attached to an outer peripheral surface of the housing, and
the second power transmission unit is radially disposed at an interval from the second power receiving unit.

8. The power transmission device according to claim 4, wherein
the second power receiving unit is attached to an outer peripheral surface of the housing, and
the second power transmission unit is axially disposed at an interval from the second power receiving unit.

9. The power transmission device according to claim 4, wherein
the rotating body is movable in an axial direction.

10. The power transmission device according to claim 1, wherein
the electric component is a state detecting unit configured to detect a state of the power transmission device in the housing.

11. The power transmission device according to claim 4, wherein
the electric component is a state detecting unit configured to detect a state of the power transmission device in the housing.
